(19) United States
(12) Patent Application Publication
(10) Pub. No.: US 2006/0144384 A1
(43) Pub. Date: Jul. 6, 2006

(54) Barbeque grill

(76) Inventor: Giovanni Santagata, Maspeth, NY (US)

Correspondence Address: Schmeiser, Olsen & Watts LLP, Suite 201, 3 Lear Jet Lane, Latham, NY, 12110, US

(21) Appl. No.: 11/326,070

(22) Filed: Jan. 5, 2006

Related U.S. Application Data
(60) Provisional application No. 60/593,310, filed on Jan. 5, 2005.

(51) Int. Cl. A47J 37/07; A47J 37/00

(52) U.S. Cl. 126/25 A; 126/41 R; 126/40; 126/50

(57) ABSTRACT

A barbeque grill having a remote to control the height of the grill surface over the firebox. In another embodiment the grill surface height is controlled automatically by a thermostat or a computer program that maximizes cooking of individual types of foods.

### CROSS REFERENCE TO RELATED APPLICATIONS

This application claims benefit to U.S. Provisional Application 60/593,310 filed on Jan. 5, 2005, the contents of which are incorporated in their entirety.

### FIELD OF ART

The invention belongs to the field of art of outdoor cooking grills, specifically charcoal and gas grills designed for the home consumer.

### BACKGROUND

The art of outdoor grilling is centuries old originating with necessity on campfires or permanent fire pits having grills racks mounted directly above the fire pit. Around a hundred years ago the bulk of the population moved into closer quarters and outdoor grilling became a form of entertainment instead of a necessity. The charcoal briquet was originally the main source of fuel for the fire box in recreational grilling, but the inherent drawbacks of the time required to start and maintain the fire and controlling the heat applied to the food led to the use of gas grills such as propane or kerosene.

Gas grills had the ability to control the amount of heat by adjusting the flame intensity usually with a knob and to warm up quickly without dealing with tending to charcoal briquets. Gas grills removed some of the problems associated with charcoal grilling, but unfortunately removed some of the benefits that were associated with outdoor grilling that were hard to duplicate with indoor cooking methods like gas only. The taste of food cooked by charcoal grills is considered to be better by many cooking enthusiasts. Gas grills do not generate smoke that flavors some foods and the heat is from the flame in gas grills instead of the glowing coals, making the type of heating of the food different. The instant invention addresses all these deficiencies present in both sources of fuel.

### SUMMARY OF INVENTION

The first embodiment of the invention is a barbeque grill comprising: a body having a cover; a firebox within the body; a grilling surface disposed directly over the firebox a cooking distance; a motor operably coupled to the grilling surface; and a device to control the cooking distance the grilling surface is disposed over the firebox.

Another embodiment is an automatic barbeque grill comprising: a body having a cover; a firebox within the body; a grilling surface disposed directly over the firebox a cooking distance; a motor operably coupled to the grilling surface; a thermocouple having a first output, wherein the thermocouple is positioned adjacent to the grill surface; a thermostat to set a cooking temperature; and a comparative circuit in electrical communication with the thermocouple, the thermostat and the motor, wherein the motor moves the grilling surface relative to the firebox to make the first output equal to the cooking temperature.

Another embodiment is a remote controlled barbeque grill comprising: a body having a cover; a firebox within the body; a grilling surface movably disposed directly over the firebox a cooking distance; a motor operably coupled to the grilling surface; a thermocouple having a first output, wherein the thermocouple is positioned adjacent to the grill surface; a thermostat to set a cooking temperature; a comparative circuit in electrical communication with the thermocouple, the thermostat and the motor, wherein the motor moves the grilling surface relative to the firebox to make the first output equal to the cooking temperature; a remote signal receiver in electrical communication with the comparative circuit; and a remote device to transmit to the remote signal receiver to control the cooking distance the grilling surface is disposed over the firebox.

### BRIEF DESCRIPTION OF THE DRAWINGS

FIG. 1 is a perspective view of the grill;

FIG. 2 is a side view of a portion of the grill;

FIG. 3 is a front view of the grill in the raised position;

FIG. 4 is a front view of the grill in the lowered position;

FIG. 5 is a front view of the grill with the hood in the raised position;

FIG. 6 is a probe for the grill;

FIG. 7 is a selector for the automatic control of the grill surface;

FIG. 8 is an optional probe and its respective jack;

FIG. 9 shows a selector for type of food and cooking intensity;

FIG. 10 shows inputs into the computer to determine ideal temperature and then a loop to raise or lower the grill surface;

FIG. 11 shows a remote control;

FIG. 12 shows the ash removal system;

FIG. 13 shows the fan assembly.

### DETAILED DESCRIPTION OF THE INVENTION

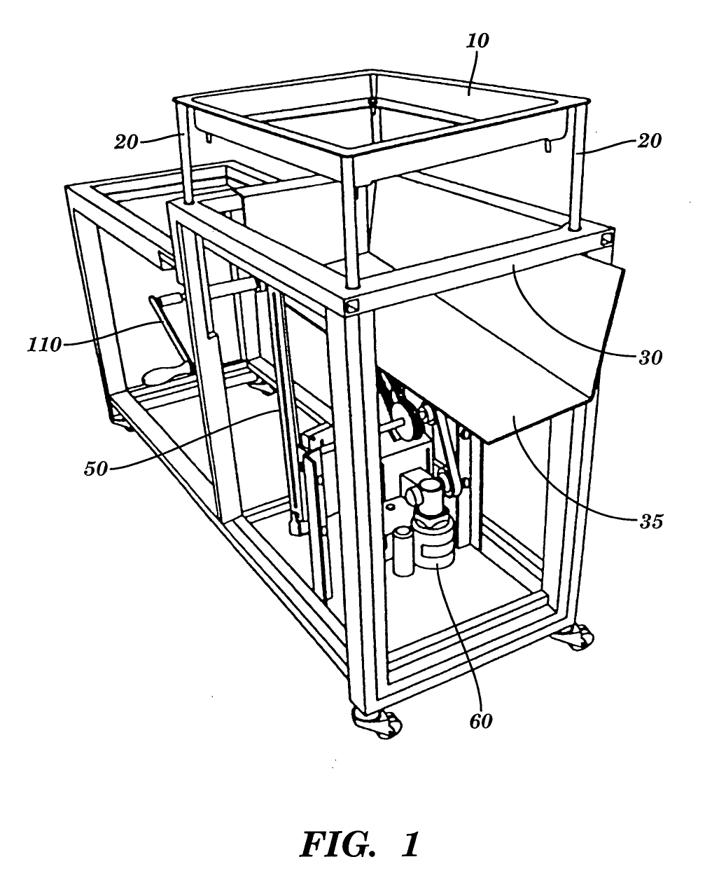

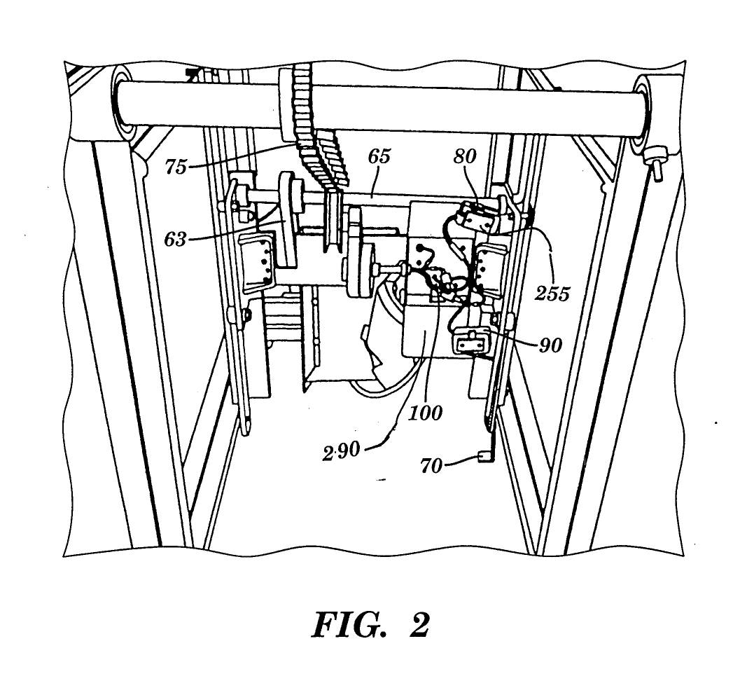

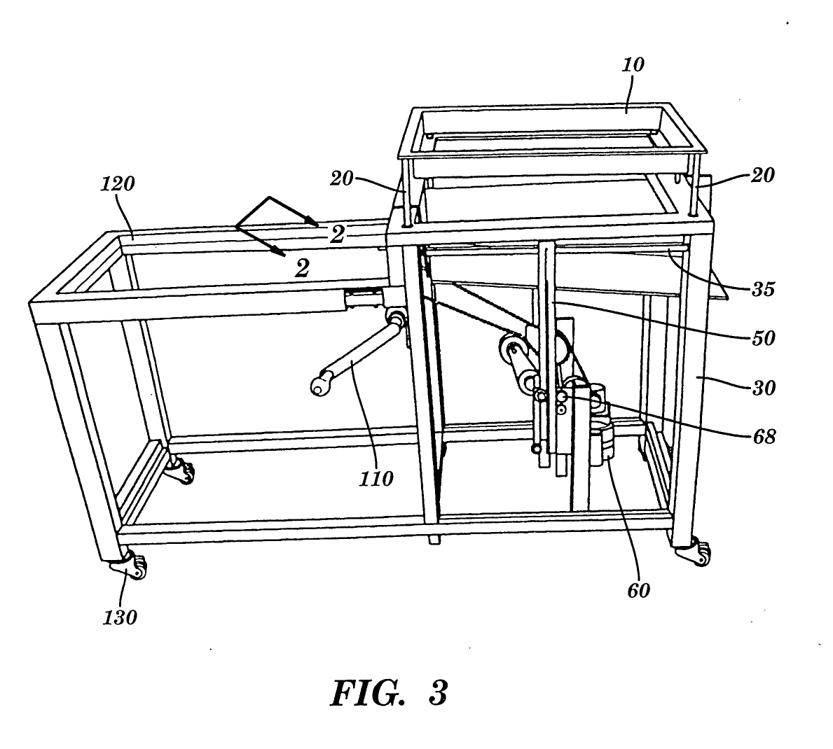

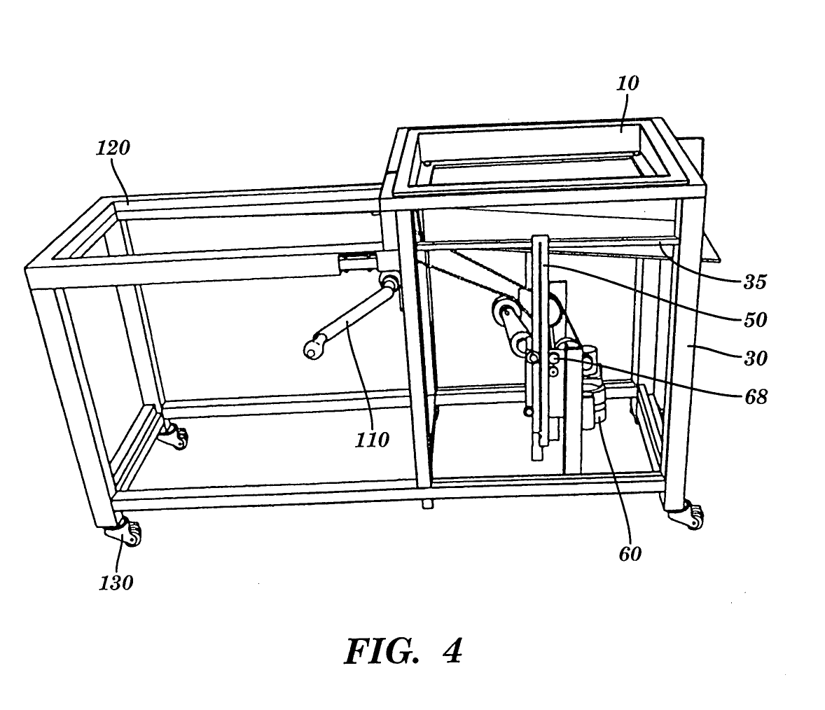

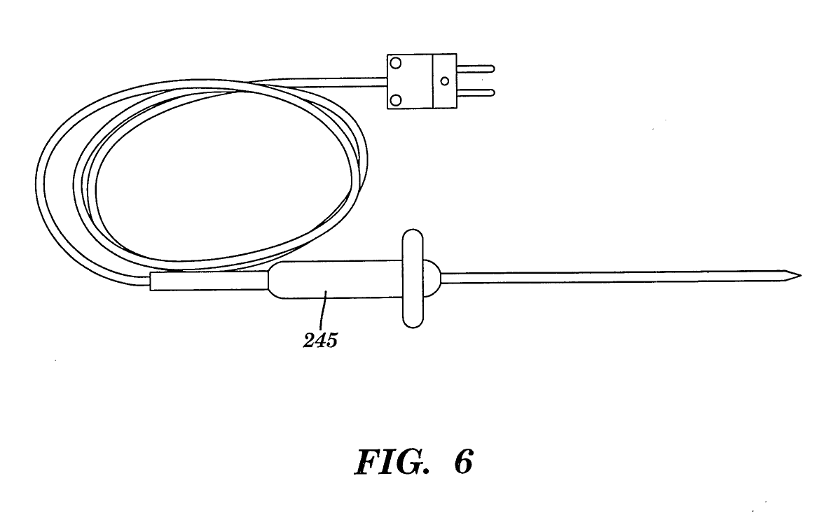

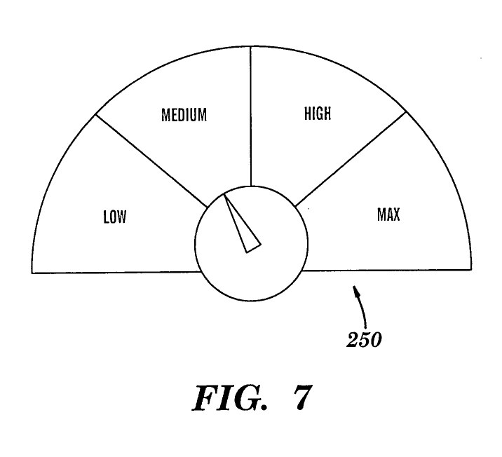

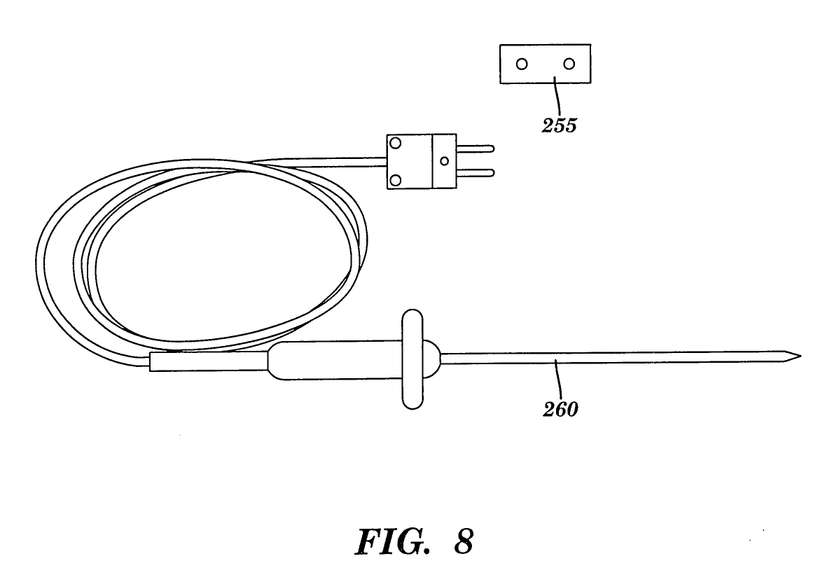

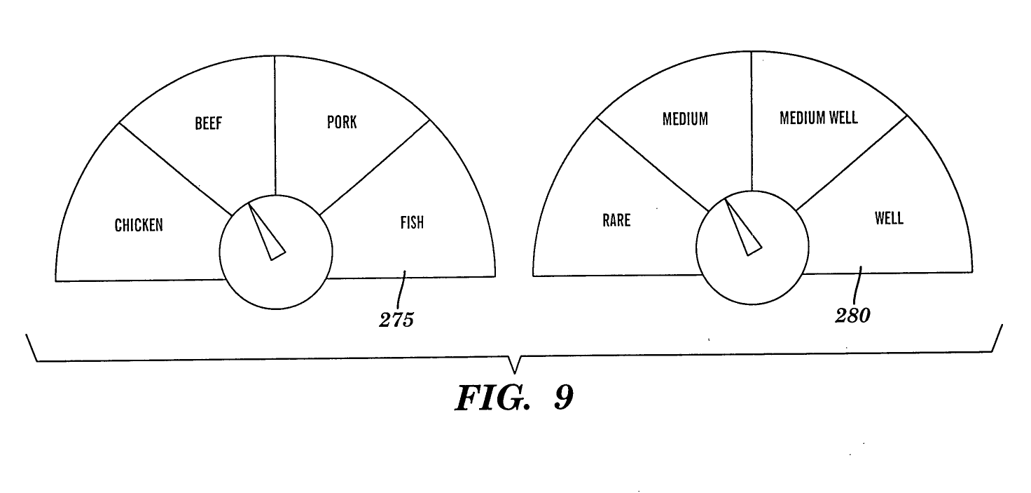

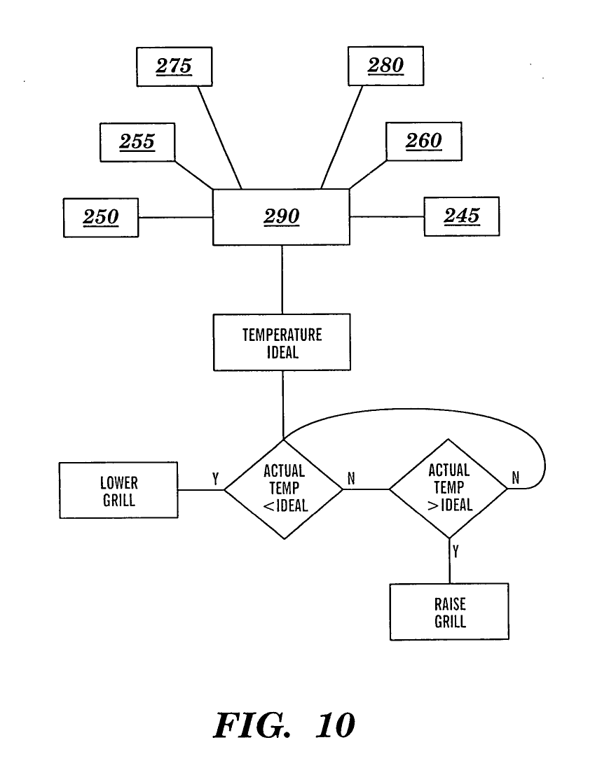

A barbeque grill 200 (FIGS. 1-13) comprises a body 210 having a cover 220 that may optionally contain catches or a hinged arm 222 to hold the cover 220 in an open position. The body 210 is made of heat resistant materials such as metal, an example would be any grade of steel or aluminum or common alloy that is used in a grill. The metal may be painted or if it is stainless it may have either a polished or brushed surface appearance for purposes of aesthetics. The body 210 may also be made of a heat resistant polymer or composite matrix if the firebox is properly shielded to prevent heat damage. The body 210 may either be a rigid box structure or it may be panels attached to a foundation structure 30 using either fasteners, welding or glue.

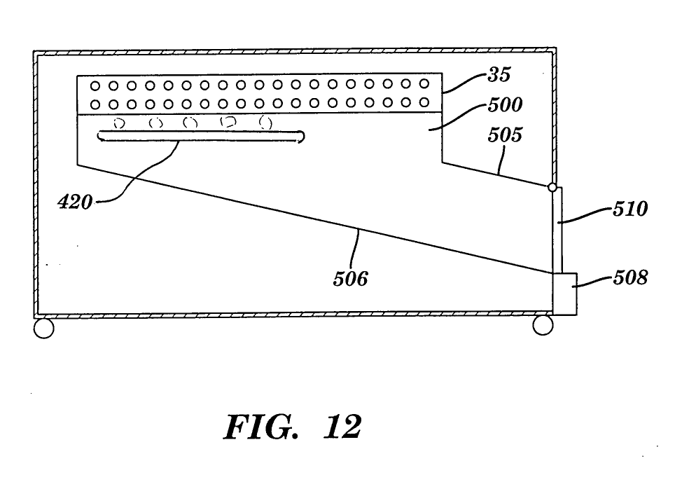

A firebox 35 that is positioned within the body 210 beneath the cover 220. The firebox 35 can either be permanently mounted to the foundation structure 30 or affixed to the body panels 210 in a manner that will not warp the body 210. In FIG. 12 the firebox 35 may comprise a tray having small holes in the bottom to assist in letting airflow travel to the charcoal briquets. Above the firebox 35 may be a grilling surface or tray 10 that may be disposed directly over or adjacent to the firebox 35 by a grill support post 20 a cooking distance. The firebox 35 can include either a gas burner 420 to either assist in the igniting and faster burn of the charcoal or in place of the charcoal where cooking with gas is desired instead of using the briquets.

A motor 60 is operably coupled to the grilling surface 10. The motor 60 may be operably coupled with a motor drive belt 63 to a gear shaft 65 that acts upon a gear 68 that may act to raise or lower the height of the grill surface tray 10. The motor 60 may be directly coupled to a screw output shaft that could raise or lower that grill surface 10 through a screw action or through a transmission or belt system. The motor 60 may also be connected to a hydraulic pump and use a piston to actuate the grill surface 10 using the grill support post 20. The motor 60 may act either directly on the grill surface 10 or be actuated by the support post 20 as discussed by the above mechanisms. The motor 60 may be overridden or assisted by a manual had crank.

A device 240 is used to control the cooking distance that the grilling surface 10 is disposed over the firebox 35. The device is selected from the group consisting of a remote control, a thermostat, a computer or a combination thereof that can be overridden with a manual hand crank. When the device 240 is a computer it uses a simple logic circuit or comparison circuit based on parameters to determine if the food is being cooked at an ideal temperature.

The grill 200 also may include a heat sensing element 245, which may be a thermocouple or a infrared heat sensor or another equivalent sensor for measuring heat that may be in the range from 100-1200F, having an electrical output 246, wherein the heat sensing element 245 is disposed adjacent the grilling surface 10 to give an approximate cooking temperature at the grill surface and wherein the heat sensing element 245 is in electrical communication with the motor 60, either directly or in a circuit with either a digital or analog computer. In conjunction with the heat sensing element 245 may be a temperature selector 250 having an electrical output 251, wherein the temperature selector 250 is in electrical communication with the motor 60 and may either be in the same circuit or a separate circuit.

A simple feedback loop may be utilized to measure the value of the heat sensing element 245 in relation to the electrical output 251 of the temperature selector 250 that could be analog such as a rheostat or other digital electrical device to set the resistance of the selector 250 that may then be matched to the output of the voltage of the heat sensing element 245 so that a temperature selection on the selector 250 would correspond to a reading from the heat sensing element 245. The device may control the polarity of the electrical flow to the motor 60 and thus direction of movement may be controlled by the polarity of the output of the circuit or it may also control a relay that may control the direction of grill surface 10. The motor 60 would shut off temporarily when hitting either the riser upper limit switch 80 or the riser lower limit switch 90. The limit switches 80, 90 would stop the motor from straining or overextending the grill surface 10 when the limits of travel of the grill surface 10 are reached. The limit switches 80, 90 could signal a buzzer or light to have the grill cook check the condition of the fuel in the firebox.

The grill may also include at least one temperature probe jack 255, wherein said jack 255 receives a signal from a temperature probe 260. The temperature probe 260 may be inserted into a portion of food such as steak or chicken to indicate a core or internal food temperature that is considered by food scientists to be the safest for consumption. The probe jack 255 may be electrically connected to the grill computer circuit 100 to indicate when a food was ready by either a buzzer or raising the food to the highest position to prevent unintentional overcooking.

The grill 200 may also optionally contain a grill position sensor 265 attached to/or in place of one of the grill supports 20. The grill position sensor 265 would have an electrical output that would indicate to the controller the position and thus the height of the grill surface 10 in relation to the firebox 35.

The grill 200 also may include a circuit 270 in electrical communication and receiving inputs from the thermostat, the heat sensing element, the temperature selector, the probe jack, the grill position sensor and the motor 60, wherein the circuit 100 compares the inputs and moves the grill to the proper position with the motor 60. The circuit 100 may be either an analog or digital circuit. The ideal temperature is from 500° F.-575° F. at the grill cooking surface 10.

When the grill 200 has a digital circuit 100 it may include features such as a food type selector 275 and include a cooking intensity selector 280 with common indicators such as (R) Rare, (M) Medium, (MR) Medium-rare, (W) Well done that when the food type such as beef is selected and the meat thermometer registers 135° F.-140° F. (R), 150° F. (M), 160° F. (W) the grill could signal that it is finished cooking or needs attention based on commonly accepted safety standards such as poultry with a minimum Thermometer Temperature 160 of 185° F. regardless of setting. When lamb is selected the Thermometer Temperature 260 that coincides: Rare=140° F. Medium=150° F. Well=160° F. For selection of pork the Thermometer Temperature 160 should be: Medium=160° F. Well Done=170. When fish is selected the cooking intensity may correlate to the thickness of the cut or type of fish cooked as contained in an instruction booklet.

These optional features would access a database of typical food types and the desired temperatures that each selection would result in such that if a selection of chicken were made and the intensity was set to rare the internal temperature would be set to the minimum safe temperature received by the internal food probe. If the cooking selector were set to well done a higher core temperature would be allowed before signaling to the chef that the food was ready. A label or instruction booklet may also be provided to include a chart of the desired center temperature. As an alternative the intensity selector may be replaced with a center food temperature selector, which would indicate when the food was finished cooking.

A computer 290 or digital circuit having commands stored in permanent memory such as ROM may facilitate the steps of: A) determining the type of food grilled from the food type selector 275; B) determining the intensity of cooking from the position of the cooking intensity selector 280; C) determining a cooking duration and a cooking temperature of the food type selected that may be controlled by an input from an internal food temperature probe; D) sampling the inputs from the thermostat, the heat sensing element, the temperature selector, the probe jack, the grill position sensor and the motor; E) adjusting the grill to the proper position; and F) signaling when the food is ready for attention. This could be accomplished through various protocol sets to direct and respond to input and process data related to the input to determine an ideal temperature and/or corresponding grill height based upon the input data. An ideal grill surface cooking temperature is 450-575 F, which could be adjusted within the range based on the intensity selector setting.

The grill 200 also may include a remote 300, wherein the remote 300 is capable of sending signals using sender 301 to the device to raise or lower the grill surface 10. In addition to a button the remote 300 may include a display 310 on the remote 300. The display 310 may be LCD, CRT or any other technology to display text or visual images either in color or black and white. The display 310 on the remote 300 may show information selected from the group consisting of time since start of grilling, grill surface temperature, grill position, internal food temperature, estimated time to finish, time to rotate and grill section selector. The display 310 may be in communication with a computer 290 either internal and/or external to the remote 300.

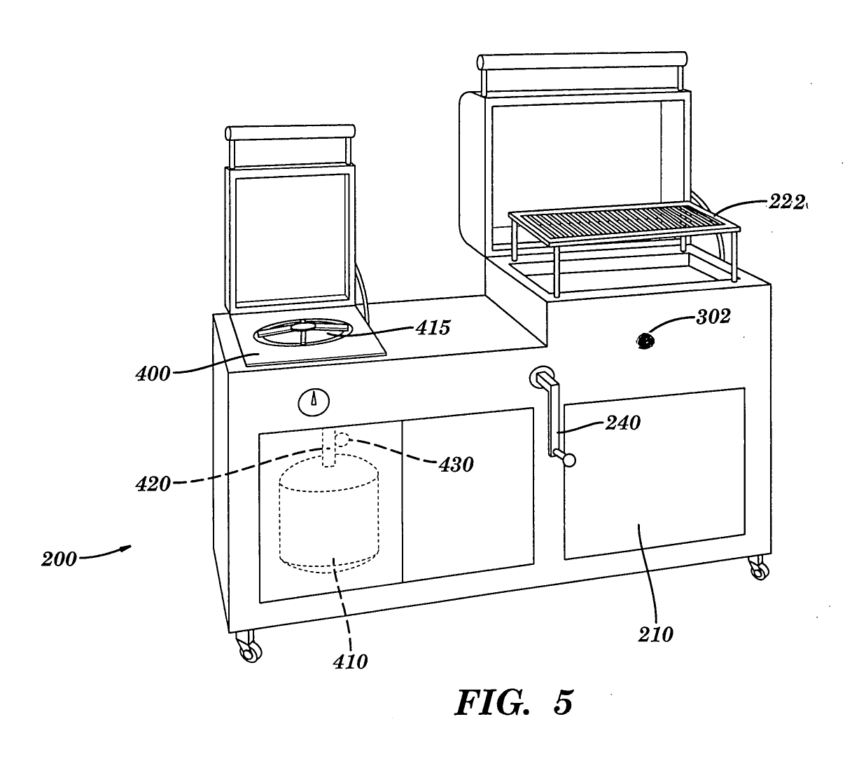

Another embodiment is an automatic barbeque grill 200 that comprises a body 210 having a cover 220 that may optionally contain catches to hold the cover 220 in an open position. The body 210 may be made of heat resistant materials such as metal such as steel or aluminum. The steel may be painted or if it is stainless it may be made into either a polished or brushed surface appearance. The body 210 may also be made of a heat resistant polymer or composite matrix. The body 210 may either be a rigid box structure FIG. 5 or it may be panels attached to a foundation structure 30 (FIGS. 1-4) such as a frame using either fasteners (rivets, screws, etc), welding or glue.

Within the body 210 is a firebox 35 that is positioned within the body 210. The firebox 35 can either be permanently mounted to the foundation structure 30 or affixed to the body panels or it may be removal to be used as a separate portable charcoal grill. Above the firebox 35 is a grilling surface or tray 10 that may be disposed either directly or indirectly over the firebox 35 a cooking distance. Optionally the grill 200 may include a gas grill heating apparatus 400 that would consist of a storage tank 410, fuel transfer lines 420 and a regulator 430. The gas grill heating apparatus may be stored within the body 210 and would allow the feature of matchless start of the charcoal in the firebox or it could be outside and attached with straps to hold the storage tank 210. Optionally the gas grill heating apparatus 400 could be fixed to a gas heating surface burner 415 similar to that found on gas home stove surfaces to allow for efficient and controlled heating of pans to boil water for such items as pasta or any other cooking chore more suited to the use of gas assembly 400.

This embodiment of the grill would use a thermocouple 245 having a first output, wherein the thermocouple 245 is positioned adjacent to the grill surface. A thermostat 250 having either heat intensity setting such as low, medium or high or the ability to set a cooking temperature. More over grill embodiments may include a comparative circuit 100 in electrical communication with the thermocouple 250, the thermostat 270 and the motor 60, wherein the motor 60 may move the grilling surface 10 relative to the firebox 35 to make the first output equal to the cooking temperature that may then control the grill surface.

Optionally a timer having a cycle of a set duration, wherein each cycle the thermostat is the control setting, and motor is a stepper motor, wherein the thermocouple is compared to the thermostat each cycle and raises the motor one step if the thermocouple is hotter than the thermostat and lowers the motor one step if the thermocouple is cooler than the thermoset.

Another optional feature shown in FIG. 12 is an ash collector 500 having at least two downward angled sides with a trap door 510 positioned at the intersection of the at least two downward angled sides 505, 506 wherein the trap door 5 10 may be use as a control of airflow to the firebox 35 and a bin 508 adjacent the trap door to collect ashes from the trap door 510.

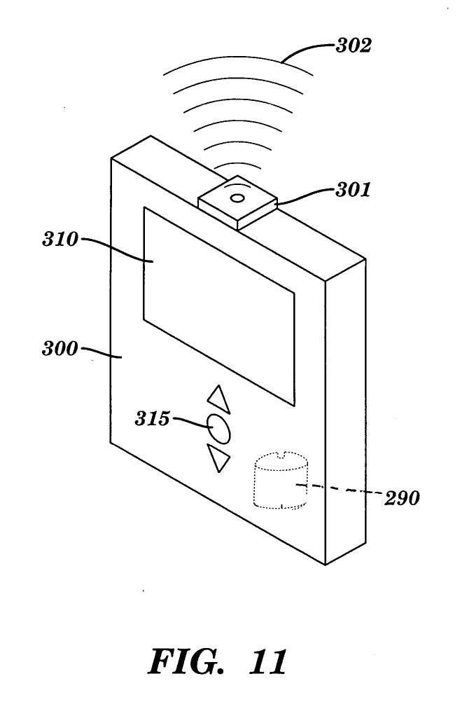

Particular grill embodiments may also include a remote control 300 having a display 310 for showing grill information and a selector 315 to change the height of the grill by the chefs specific desires to cook the selected item as shown in FIG. 11. Additionally a manual crank arm 240 may also be used to position the surface of the grill 10 without the use of the motor 60 if either the motor 60 is disabled by something like power loss or the remote 300 is misplaced as shown in FIGS. 1-5. Also a mechanism to rotate grill cooking surface 10 either continuously or at timed intervals may also be included in the form of a second grill surface adjacent the first surface to hold grilling food items there between during rotation.

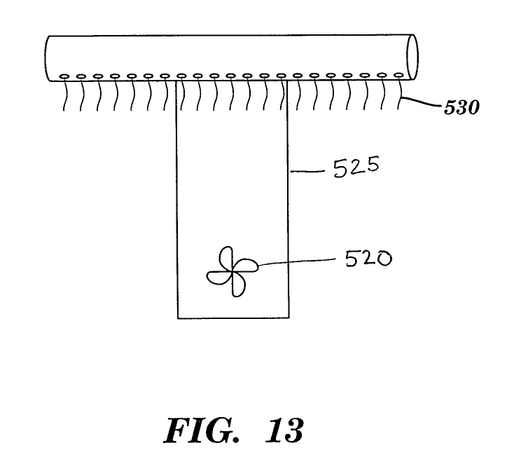

Another feature shown in FIG. 13 that may be included is a fan 520 possibly housed in a shroud 525 to direct airflow 530 onto the charcoal to decrease the time required to reach a heat sufficient to start cooking. The fan 520 and shroud 525 may be removably positioned to direct airflow onto the charcoal to decrease heating times.

Another embodiment may comprise a remote controlled barbeque grill 200 that may comprise a body 210 having a cover 220 with a firebox 35 positioned within the body 210. At least one grilling surface 10 may be movably disposed directly over the firebox 35 a cooking distance.

The grilling surface 10 may be raised or lowered by a motor 60 operably coupled to the grilling surface 10. The grill surface temperature is read with a thermocouple 245 having an output 246, wherein the thermocouple 245 is positioned adjacent to the grill surface 10. The chef then has the ability to use a thermostat 250 to set a cooking temperature 251 that is read by the thermocouple as output 246. A comparative circuit 290 in electrical communication with the thermocouple 245, the thermostat 250 and the motor 60 all act in unison to maintain the proper height of the grill when put into the automatic setting. When in the automatic setting the motor 60 is given commands to move the grilling surface 10 relative to the firebox 35 to make the thermocouple output temperature 246 equal approximately to the desired cooking temperature controlled by the thermostat 250.

On the outer surface of the body 210 may be a remote signal receiver 302 that may be in electrical communication with the comparative circuit 290 as shown in FIG. 5. A remote device 300 transmits via the sender 301 to the remote signal receiver 302 to control the cooking distance the grilling surface 10 is disposed over the firebox 35.

Optionally a temperature control selector 250 can be disposed on the remote device 300 in the form or either a button, a knob or in the form of a video display that may be a touchscreen. The remote device 300 would have a signal generator 301 in communication with the temperature control 250 on the remote. The signal generator 301 produces a signal 302 transmitted from the remote 300 selected from the group consisting of infrared light, laser light, radio waves or microwaves, or other electromagnetic transmission including sonic or ultrasonic transmissions.

The remote 300 on the display 310 could include the following menu of possible cooking choices and directions as a suggestion for more sophisticated automated cooking based on the

Cut of Meat Weight or Thickness Grilling Method Approximate Cooking Time:

### Beef Cooking Chart:

Standing Rib Roast 3½ lbs.-5 lbs. Indirect 23-27 min/lb (R)

Standing Rib Roast 6 lbs.-8 lbs. Indirect 17-23 min/lb (R)

Boned & tied roasts (rib, sirloin tip, crossrib) 2.5 lbs.-4.5 lbs. Indirect 23-27 min/lb (R)

Steaks (T-bone, New York, Porterhouse, top round, sirloin; chuck steak if marinated or tenderized) 1 in. Direct 5-6 min/side (R)

Steaks (T-bone, New York, Porterhouse, top round, sirloin; chuck steak if marinated or tenderized) 1½ in. Direct 8-9 min/side (R)

Steaks (T-bone, New York, Porterhouse, top round, sirloin; chuck steak if marinated or tenderized) 2 in.-2½ in. Direct 8-9 min/side (R)

Flank Steak 1 in.-1½ in. Direct 5-7 min/side (MR)

Skirt steak (cut into serving size pieces) ⅛ in.-¼ in. Direct 1½-2 min/side (R)

Skirt steak (cut into serving size pieces) ½ in. Direct 2½-3 min/side (R)

Boneless Cubes ¾ in. Direct 5-6 min total (MR)

Boneless Cubes 1 in. Direct 8-10 min total (MR)

Boneless Cubes 1½ in. Direct 15 min total (MR)

Ground Beef Patties Direct 4-5 min/side (R), 5-6 min/side (M), 6-7 min/side (W)

The settings of selector 275 when set to beef would apply wherein (R) Rare, (M) Medium, (MR) Medium-rare, (W) Well done coincides to where the Meat thermometer 260 registers 135° F.-140° F. (R), 150° F. (M), 160° F. (W).

### Lamb Cooking Chart:

Cut of Meat Weight or Thickness Grilling Method Approximate Cooking Time

Leg, Bone- In 5-7 lbs. Indirect 22-25 Min/Lb. (M)

Leg, Boned & Tied 4-5 lbs. Indirect 27-30 Min/Side (M)

Leg, Boned & Butterflied 4-5 lbs. Indirect 15-17 Min/Side (M)

Rack 2-3 lbs. Indirect 8-20 Min./Side (MR)

Chops (Loin, Rib, Shoulder) ¾ in. Direct 4-5 Min/Side (MR)

Chops (Loin, Rib, Shoulder) 1 in. Direct 5 Min/Side (MR)

Chops (Loin, Rib, Shoulder) 1½ in. Direct 6-7 Min./Side (MR)

Boneless Cubes (for kabobs) ¾ in. Direct 5 Min. Total (R), 6-8 Min. Total (M) 8-10 Min. Total (W)

Boneless Cubes (for kabobs) 1 in. Direct 6 Min. Total (R), 8 Min. Total (M) 12 Min. Total (W)

Boneless Cubes (for kabobs) 1½ in. Direct 12 Min. Total (R), 15 Min. Total (M) 17 Min. Total (W)

When the meat is set to lamb and the cooking intensity is set for (R) Rare; (M) Medium; (MR) Medium Rare; (W) Well Done then the internal prob temperature 160 has a Thermometer Temperature: Rare=140° F. Medium=150° F. Well=160° F.

### Poultry Cooking Chart

Cut of Meat Weight or Thickness Grilling Method Approximate Cooking Time

Chicken, Whole 3-4 lbs. Indirect 1¼-1¼ Hrs.

Chicken, Whole 6-7 lbs. Indirect 1½-1¾ Hrs.

Halved or Quartered 3-4 lbs. total Indirect 55-65 Min.

Breasts, Boneless 4-6 oz./ea. Direct or Indirect 12-15 Min.(Direct) 23-25 Min. (Indirect)

Wings 3-4 oz./ea. Direct or Indirect 25-30 Min. (direct) 35-40 Min.(Indirect)

Cornish Game Hens 1-1½ lbs. Indirect 45-60 Min.

Turkey, Whole 9-12 lbs. Indirect 2-3 Hrs.

Turkey, Whole 13-16 lbs. Indirect 2¾-3¾ Hrs.

Turkey, Whole 18-22 lbs. Indirect 3½-4½ Hrs.

Breast Halves, Bone In 2½-3 lbs. Indirect 1-1½ Hrs.

Drumsticks, Thighs 1-2 lbs./ea. Direct, Covered 55-65 Min.

Boneless Cubes (For Kabobs) 1 inch Direct 12-15 Min. Total

Breast Steaks, Boneless ½ inch Direct 3½-4½ Min./Side

Ground Turkey Patties ¾-1 inch Direct 5-7 Min./Side

The poultry is cooked to an internal temperature of 185 F to ensure that the food will not create illness. The internal temperature probe is set to the minimum temperature for poultry regardless of the setting on the intensity selector.

Seafood Cooking Chart:

Frozen fillets should not be thawed before grilling. Cooking times will be approximately double that of fresh fish and that could be an optional selection to indicate if it was frozen when grilled. Type of Fish or Shellfish Weight or Thickness Grilling Method Approximate Cooking Time

Whole Fish(with or without head and tail) ½-1 lb. Indirect 6 min./side

Whole Fish(with or without head and tail) 3-5 lbs. Indirect 30-35 min. total

Whole Fish(with or without head and tail) 5-7 lbs. Indirect 45 min. total

Steaks & Fillets ½ in. Direct 2-3 min./side

Steaks & Fillets ¾ in. Direct 3-4 min./side

Steaks & Fillets 1 in. Direct 4-5 min./side

Steaks & Fillets 1½ in. (2-3 lbs.) Indirect 15-18 min. total

Boneless Cubes (for Kabobs) (Use firm fish) 1 in. Direct 8-10 min. total

Shrimp Medium-size (30-32 per lb.) Direct 1½-2½ min./side

Scallops About 1 in. cubes Direct 5-7 min. total

### Pork Cooking Chart

Cut of Meat Weight or Thickness Grilling Method Cooking Time

Half Leg, (shank or butt), bone-in 5-9 lbs. Indirect 25-30 min./lb.

Loin Roast, half, bone-in 3½-7 lbs. Indirect 22-24 min./lb.

Loin Roast, half, boned & tied 2-5 lbs. Indirect 20-22 min./lb.

Loin Roast, rib or sirloin end, bone-in 2-5 lbs. Indirect 28-30 min./lb.

Shoulder Roast, (picnic or butt) bone-in 4-6 lbs. Indirect 26-29 min./lb.

Shoulder Roast, (picnic or butt) boned & tied 3-5 lbs. Indirect 30-32 min./lb.

Tenderloin ½-1 lbs. Indirect 18-22 min. total

Chops (loin, rib, shoulder); leg, steaks ¾ in. Direct 4-5 min./side

Chops (loin, rib, shoulder); leg, steaks 1 in. Direct 5-7 min./side

Chops (loin, rib, shoulder); leg, steaks 1½ in. Direct 8-10 min./side

Spareribs 2½-3 lbs. Indirect 1-1¼ hrs. total

Spareribs, country style 3-4 lbs. Indirect 1-1¼ Hrs. total

Boneless Cubes (for kabobs) ¾ in. Direct 8 min. total

Boneless Cubes (for kabobs) 1 in. Direct 12-14 min. total

For selection of pork the Thermometer Temperature 160 should be: Medium=160° F. Well Done=170° F.

The above charts containing either additional or fewer selections could be programmed into the grills memory or be programmed into the remote itself. The remote optionally could synchronize with a computer connected to the internet for downloading additional information. It is optional to have the whole computer circuit being contained within the remote itself wherein the remote could get feedback from the grill about current cooking conditions such as temperature, grill height and meat internal temperature.

When the grill 200 is finished cooking the ash collector having at least two downward angled sides 505, 506 has a second advantage in that they assist in cleaning of the grill 200. Water can be sprayed into the grill from a source such as a garden hose, which would flow out the a trap door 510 positioned at the intersection of the at least two downward angled sides 505, 506 and into a catch bin 508. The catch bin 508 can then be removed for dumping into approved waste disposal locations.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims. The claims provide the scope of the coverage of the invention and should not be limited to the specific examples provided herein.

I claim:

1. A barbeque grill comprising:
a body having a cover;
a firebox within the body;
a grilling surface disposed directly over the firebox a cooking distance;
a motor operably coupled to the grilling surface; and
a device to control the cooking distance the grilling surface is disposed over the firebox.

2. The grill of claim 1 wherein the device is selected from the group consisting of a remote control, a thermostat, or a combination thereof.

3. The grill of claim 1 further comprising:
a heat sensing element having an electrical output, wherein the heat sensing element is disposed adjacent the grilling surface and wherein the heat sensing element is in electrical communication with the motor; and
a temperature selector having an electrical output, wherein the temperature selector is in electrical communication with the motor.

4. The grill of claim 1 further comprising:
a selector switch having an electrical output, wherein the selector switch is in electrical communication with the motor.

5. The grill of claim 3 further comprising:
at least one temperature probe jack, wherein said jack receives a signal from a temperature probe.

6. The grill of claim 5 further comprising:
a grill position sensor;
a circuit in electrical communication and receiving inputs from the thermostat, the heat sensing element, the temperature selector, the probe jack, the grill position sensor and the motor, wherein the circuit compares the inputs and moves the grill to the proper position with the motor based on ideal temperature;
a food type selector;
a cooking intensity selector; and
a computer performing the steps of:
determining the type of food grilled;
determining the intensity of cooking;
determining a cooking duration and a cooking temperature of the food type selected;
sampling the inputs from the thermostat, the heat sensing element, the temperature selector, the probe jack, the grill position sensor and the motor;
adjusting the grill to the proper position; and
signaling when the food is ready for attention.

7. The grill of claim 1 further comprising:
a ducted fan having an output directed into the firebox.

8. The grill of claim 1 further comprising:
a remote, wherein the remote is capable of sending signals to the device to raise or lower the grill; and
a display on the remote.

9. The grill of claim 8 wherein the display shows information selected from the group consisting of time since start of grilling, grill surface temperature, grill position, internal food temperature, estimated time to finish, time to rotate and grill section selector.

10. An automatic barbeque grill comprising:
a body having a cover;
a firebox within the body;
a grilling surface disposed directly over the firebox a cooking distance;
a motor operably coupled to the grilling surface;
a thermocouple having a first output, wherein the thermocouple is positioned adjacent to the grill surface;
a thermostat to set a cooking temperature; and
a comparative circuit in electrical communication with the thermocouple, the thermostat and the motor, wherein the motor moves the grilling surface relative to the firebox to make the first output equal to the cooking temperature.

11. The grill of claim 10 further comprising:
a comparative circuit, wherein the thermocouple is compared to the thermostat each cycle and raises the motor if the thermocouple is hotter than the thermostat and lowers the motor if the thermocouple is cooler than the thermoset.

12. The grill of claim 10 further comprising:
an ash collector having at least two downward angled sides;
a trap door positioned at the intersection of the at least two downward angled sides wherein the trap door controls airflow to the firebox; and
a bin adjacent the trap door to collect ashes from the trap door.

13. The grill of claim 10 further comprising:
a remote control having a display for showing grill information; and
a selector to change the height of the grill.

14. The grill of claim 10 further comprising:
a mechanism to rotate grill cooking surface.

15. A remote controlled barbeque grill comprising:
a body having a cover;
a firebox within the body;
a grilling surface movably disposed directly over the firebox a cooking distance;
a motor operably coupled to the grilling surface;
a thermocouple having a first output, wherein the thermocouple is positioned adjacent to the grill surface;
a thermostat to set a cooking temperature;
a comparative circuit in electrical communication with the thermocouple, the thermostat and the motor, wherein the motor moves the grilling surface relative to the firebox to make the first output equal to the cooking temperature;
a remote signal receiver in electrical communication with the comparative circuit; and
a remote device to transmit to the remote signal receiver to control the cooking distance the grilling surface is disposed over the firebox.

16. The grill of claim 15 further comprising:
a temperature control selector disposed on the remote device;
a signal generator in electrical communication with the temperature control; and
a signal transmitted from the remote selected from the group consisting of infrared light, laser light, radio waves or microwaves.

17. The grill of claim 15 further comprising:
a transmission, wherein said transmission is coupled to said motor and said grilling surface.

18. The grill of claim 17 further comprising:
a handle connected to the transmission.

19. The grill of claim 17 wherein the transmission is selected from the group consisting of chains, screws, hydraulic piston, rods, levers, gears, pulleys and combinations thereof.

20. The grill of claim 15 further comprising:
an ash collector having at least two downward angled sides;
a trap door positioned at the intersection of the at least two downward angled sides.
